(19) United States
(12) Patent Application Publication
(10) Pub. No.: US 2013/0046561 A1
(43) Pub. Date: Feb. 21, 2013

(54) PERSON-TO-PERSON LENDING PROGRAM PRODUCT, SYSTEM, AND ASSOCIATED COMPUTER-IMPLEMENTED METHODS

(71) Applicant: Trent Sorbe, Brookings, SD (US)

(72) Inventor: Trent Sorbe, Brookings, SD (US)

(21) Appl. No.: 13/214,126

(22) Filed: Aug. 19, 2011

(51) Int. Cl. G06Q 40/00

(52) U.S. Cl. 705/4; 705/38

(57) ABSTRACT

An individual consumer borrower accessing a person-to-person lending website is provided an opportunity to have a loan request wholly or partially satisfied by a financial institution at loan terms from the financial institution. The financial institution, for example, can receive information about a person-to-person loan request, determine whether to authorize a financial institutional loan, offer a loan to the individual on terms determined by the financial institution, and issue the loan to an individual consumer borrower responsive to approval of the terms. Prior to an auction, the individual consumer can choose an immediate loan offer having financial institution terms or choose to solicit individual consumer loan offers with more favorable terms through the person-to-person lending website. The financial institution can also offer a gap filling loan for a deficiency amount so that the loan request can be partially satisfied by individual consumer loan offers.

### BACKGROUND OF THE INVENTION

1. Related Applications

This application claims priority to and the benefit of U.S. Provisional Patent Application No. 61/033,069, titled “Person-to-Person Lending Program Product, System, and Associated Methods”, filed on Mar. 3, 2008, incorporated herein by reference in its entirety.

2. Field of Invention

The present invention relates generally to the financial service and lending industries, and, more particularly, to products, systems, and associated methods to finance a gap filling loan for a deficiency amount associated with a person-to-person loan request and to provide loans and guarantees from a financial institution for loan requests associated with a person-to-person lending.

3. Description of the Related Art

Person-to-person lending, sometimes called P2P lending or alternately peer-to-peer lending, involves individual consumers making loans to other individual consumers. Increasingly prevalent, person-to-person lending enjoys significant, favorable publicity and positive feedback from United States bank regulators. Today, various person-to-person or peer-to-peer (“P2P”) lending websites have been developed and launched to provide access to loans, typically unsecured loans, to individual consumers.

A large number of borrowers, however, do not get their loan requests fully funded. Borrower requests far exceed lender dollars available. Because some P2P lending websites utilize group or affinity relationships, such as relationships in Facebook or other social media websites, borrowers with no group or affinity relationship can have difficulty attracting individual lenders. Borrowers also can make poorly thought-out or confusing loan requests, putting off individual consumer lenders. In addition, mislabeled credit grades and overly-simplified credit grading can result in borrowers not getting their loans fully funded.

Perhaps negatively affecting the P2P lending marketplace, state regulations in many states limit lending interest rates. Moreover, the P2P lending market suffers from, in general, a lack of sophisticated underwriting models to qualify borrowers and access to many secondary capital markets.

It is known that millions of prepaid cards are issued each year in the United States. It is also known that many of the customers of prepaid cards rely primarily on cash and a prepaid card account for their personal finances; these customers often do not have a traditional checking, savings, or other bank deposit account, and they usually do not write checks.

### SUMMARY OF INVENTION

In view of the foregoing, Applicant has recognized one or more source of many of these problems and provides enhanced embodiments of computerized methods of financing an individual consumer loan request associated with P2P lending, and associated systems and computer program products. Embodiments of the present invention, for example, provide financing for a deficiency amount for a P2P loan request, quickly satisfying a P2P loan request, and guaranteeing a P2P loan.

According to embodiments of the present invention, when an individual consumer borrower associated with a P2P lending website, or other P2P communication network, does not have a loan request fully funded for the preselected loan value by individual consumer lenders, for example, a financial institution such as a bank can finance a gap filling loan for the deficiency amount at preselected loan terms from the financial institution. The financial institution identifies the deficiency amount for a P2P loan request, determines whether to authorize a financial institutional loan for the deficiency amount, authorizes a gap filling loan at preselected loan teems from the financial institution, and issues the loan to an individual consumer borrower responsive to approval of the preselected terms. As understood by those skilled in the art, the financial institution serves as stop-gap for loan requests that are not fully funded but meet the financial institution's credit strategy to thereby fulfill an uncommitted portion of the loan requests. Some benefits include, for example, a significant increase in loan closings because otherwise unsatisfied loan requests gain a second opportunity to obtain needed funds. In addition, individual consumer borrowers now have an option of a blended loan or interest rate, according to embodiments of the present invention. For example, if a borrower posts a request for $5,000 with a 10% maximum rate limitation and lenders offer a total of $4,000 at the 10% interest rate, the financial institution can offer to loan the remaining $1,000, the deficiency amount, at a rate of 15%. The borrower can then choose to accept a blended rate of 11% (being $4,000 at 10% and $1,000 at 15%), in addition to the options of a $4,000 loan at 10%, or no loan at all. Moreover, the involvement of the financial institution, for example, can advantageously put competitive or timing pressures on individual consumer lenders to thereby force greater competition among the lenders and add an increase time component to bidding or offering P2P loans.

According to other embodiments of the present invention, a financial institution can provide immediate financing terms responsive to an individual consumer borrower loan request of a preselected loan value associated with a P2P lending website so that the individual consumer can choose the immediate loan offer with terms determined by the financial institution or choose to solicit individual consumer loan offers with more favorable terms through the P2P lending website. As understood by those skilled in the arts, the immediate financing option provided by the financial institution, for example, can guarantee that the loan will be funded (assuming the borrower is willing to accept the terms of the financial institution) and establishes a ceiling on the “zone of possible agreement.” For example, if a borrower posts a request for $5,000 with a 10% maximum rate limitation, the financial institution can offer immediate financing at a rate of 15%. The borrower can then choose to accept the rate of 15% immediately, if timing is critical, or choose to wait for individual consumer loan offers with a more favorable rate, if timing is less critical. As understood by those skilled in the art, the benefits of immediate financing embodiments and gap filling loan embodiments, especially in combination when the borrower is effectively prequalified for the gap filling loan, include an increase in loan closings and an increase in the availability of a blended rate for the borrower. The blended rate may or may not exceed the desired rate or a maximum rate of the P2P loan request, as understood by those skilled in the art.

According to yet other embodiments of the present invention, a financial institution can guarantee a P2P loan associated with a P2P lending website. The P2P lending website receives the loan request. Then the financial institution determines whether to authorize insurance products associated with the P2P loan request; offers for purchase one or more insurance products, including, for example, debt cancellation insurance and credit life insurance; and issues insurance products responsive to its purchase and the closing of the P2P loan. As understood by those skilled in the art, the availability of insurance products, such as, for example, debt cancellation insurance and credit life insurance, can reduce lender risk, improve the comfort level of a lender with respect to repayment, and provide assurance to a lender, resulting in a greater willingness to enter into loans. Therefore, embodiments of the present invention result in a significant increase in loan closings as more individual consumers are willing to lend money with the financial institution offering insurance. As an example, a lender is “on the fence” on a particular loan request, but is willing to lend with the guarantee of a bank or other financial institution. Then the lender can purchase a guarantee from a financial institution for an agreed upon fee based on the borrower's risk profile. If borrower defaults, the financial institution repays lender's unpaid balance owed and steps into the lender's repayment position.

According to another embodiment of the present invention, the financial institution can be a federally-chartered bank subject to federal banking laws and regulations and not subject to state banking laws and regulations. Therefore, the federally-chartered financial institution enjoys rate preemption; that is, state licensing requirements, as well as regulations in many states that limit lending interest rates, are preempted and do not apply to the federally-chartered financial institution. As understood by those skilled in the art, a federally-chartered financial institution can operate in every state with a consistent implementation nationally rather than a state-by-state approach and can charge any loan or interest rate for the gap filling loans or immediate financing loans without regard to state law. For example, if a borrower posts a loan request for $5,000 and the borrower resides in a state with a 10% maximum interest rate limitation, the financial institution can offer immediate financing or a gap filling loan at an interest rate of 15%. In addition, if the borrower resides in a state where the P2P lending website does not have a license needed to operate, rather than reject the customer, however, the P2P lending website can disclose that the financial institution is willing to fulfill the entire loan request value at a rate of, for example, 17% immediately.

Embodiments of the present invention also include additional features. For example, the financial institution can bundle the gap filling loans, immediate financing loans, or both for sale on secondary capital markets, as understood by those skilled in the arts. According to embodiments of the present invention, the financial institution can employ sophisticated underwriting models and preselected authorization parameters to determine whether to authorize a gap filling loan, a financial institutional loan for the entire selected loan value, and one or more insurance products to guarantee the loan. In addition, the financial institution can load the loan value to a prepaid card according to embodiments of the present invention so that the loan request is converted into a prepaid card having an associated value and being capable of purchasing goods and so that the P2P lending marketplace is not limited to individual consumers with traditional bank accounts, checking accounts, and other such accounts as understood by those skilled in the arts, but expanded to include those using prepaid cards who otherwise may have difficulty in accessing the P2P lending marketplace.

Embodiments of the present invention provide other benefits to the P2P lending website. An association with the financial institution, for example, can legitimize the P2P lending website. The addition of gap filling loans, according to the embodiments of the present invention, allows the P2P lending website to preserve its social feel with the financial institution serving simply as a backstop for both individual consumer borrowers and lenders. Also, reporting the financial institution performance, as understood by those skilled in the arts, can create a “Beat the Stuffy, White Shirt Banker” promotional opportunity for the P2P lending website.

For a financial institution, for example, embodiments of the present invention provide additional benefits, including a low cost customer acquisition channel and cross marketing opportunities for other products and services. As understood by those skilled in the arts, the financial institution can purchase receivables from the individual consumer lenders, forming a secondary market and providing individual consumer lenders the ability to access cash tied up in loans.

Additionally, the financial institution can share its sophisticated underwriting models and preselected authorization parameters with individual consumer lenders wanting to piggyback on the financial institution's credit standards according to embodiments of the present invention to thereby further legitimize the P2P lending website and the underwriting and performance data reported by the P2P lending website, as understood by those skilled in the art.

Embodiments of the present invention provide, for example, a system to finance an individual consumer loan request associated with a P2P lending website. The system can include a first computer defining a borrower computer, which includes a program product, e.g., software, stored in memory to provide information for a P2P loan request through an electronic communications network, e.g., the Internet or World Wide Web, to a second computer defining a P2P lending website computer. The P2P lending website computer has an electronic forum for hosting a P2P loan request and for loan offers by one or more individual consumer lenders. The loan request information includes a preselected loan value. Each loan offer associated with the electronic forum is responsive to the P2P loan request and has a loan value that fulfills all or a portion of the P2P the preselected loan value. The system further includes one or more third computers defining a lender computer, which can include, for example, a program product stored in memory to provide loan offer information responsive to the P2P loan request to the P2P lending website computer through the electronic communications network. The system also, for example, can include a fourth computer defining a financial institution computer, which receives loan information from the P2P lending website computer through the electronic communications network. The financial institution computer can include a program product, for example, as discussed below.

Embodiments of the present invention include, for example, a program product associated with a financial institution computer, stored on a tangible computer memory media, operable on a computer, and used to finance an individual consumer loan request. The computer program product, for example, can include a set of instructions that, when executed by the computer, cause the computer to perform various operations. The operations include identifying a deficiency amount for the P2P loan request associated with the P2P lending website. The deficiency amount is the difference between the preselected loan value of the P2P loan request and a value of an aggregate of any individual consumer loan offers responsive to the P2P loan request, if the value of the aggregate is less than the preselected loan value. The operations also include the financial institution determining whether to authorize a gap filling loan for the deficiency amount to an individual consumer requesting the loan and authorizing the gap filling loan for the deficiency amount at preselected loan terms from the financial institution. The operations further include issuing the gap filling loan to the individual consumer making the P2P loan request responsive to approval of the preselected terms by the individual consumer.

In addition, embodiments of the present invention include other program products, systems, and associated methods for satisfying a P2P loan request, as will be understood by those skilled in the art.

### BRIEF DESCRIPTION OF DRAWINGS

So that the manner in which the features and benefits of the invention, as well as others which will become apparent, may be understood in more detail, a more particular description of the invention briefly summarized above may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1 is a schematic flow diagram of a method of financing a deficiency amount for a P2P loan request according to an embodiment of the present invention;

FIG. 2 is a schematic flow diagram of a method of satisfying a P2P loan request according to an embodiment of the present invention;

FIG. 3 is a system to finance an individual consumer loan request according to an embodiment of the present invention;

FIG. 4 is a partial schematic diagram of a computer program product for financing a deficiency amount for a P2P loan request according to an embodiment of the present invention;

FIG. 5 is a partial schematic diagram of a computer program product of satisfying a P2P loan request according to another embodiment of the present invention;

FIG. 6 is a flowchart of a process of issuing a gap filling loan from a financial institution according to an embodiment of the present invention;

FIG. 7 is a flowchart of a process of issuing a loan or insurance product from a financial institution responsive to a P2P loan request according to an embodiment of the present invention;

FIGS. 8A and 8B are respective front and rear views of a prepaid card according to embodiments of the present invention; and

FIG. 9 is a schematic block diagram of a point-of-sale hardware device according to an embodiment of the present invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

Embodiments of the present invention provide computerized methods of financing an individual consumer loan request associated with a P2P lending website, and associated systems and program products. Embodiments of the present invention provide for financing a deficiency amount for a P2P loan request, quickly satisfying a P2P loan request with a loan from a financial institution, and guaranteeing a P2P loan through insurance products.

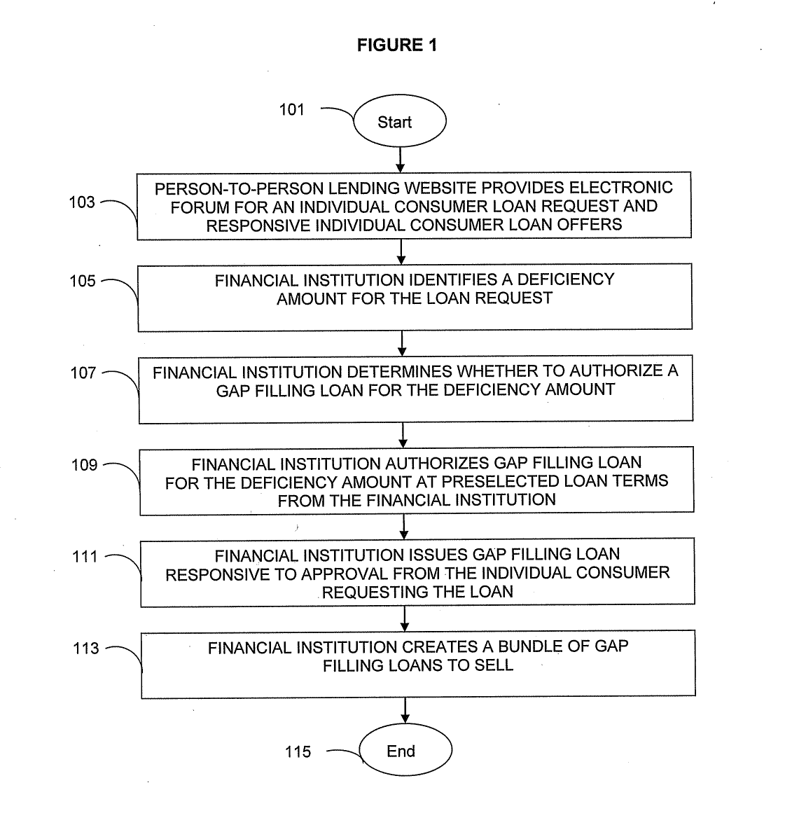

FIG. 1 illustrates an embodiment of the present invention which provides a computerized method of financing a deficiency amount for a P2P loan request. The method, for example, includes a P2P lending website providing an electronic forum for a P2P loan request by an individual consumer and for loan offers by one or more individual consumers (block 103). The loan request has a preselected loan value. The loan request can include a purpose for the loan, such as, a home improvement, travel, education expenses, and others as understood by those skilled in the art. Each loan offer is responsive to the P2P loan request and has a loan value that fulfills all or a portion of the preselected loan value. The method also includes identifying a deficiency amount for the P2P loan request associated with the P2P lending website (block 105). The deficiency amount is the difference between the preselected loan value of the P2P loan request and a value of an aggregate of any individual consumer loan offers responsive to the P2P loan request, if the value of the aggregate is less than the preselected loan value, for example. The method further includes determining whether to authorize a gap filling loan for the deficiency amount from a financial institution to the individual consumer requesting the loan (block 107) and authorizing the gap filling loan for the deficiency amount at preselected loan terms from the financial institution (block 109). The method continues with issuing the gap filling loan to the individual consumer making the P2P loan request responsive to approval of the preselected terms by the individual consumer (block 111). The method further includes the financial institution creating a collection of a plurality of P2P loans to define a bundle of P2P loans to sell, in which a bundle includes one or more gap filling loans (block 113).

As understood by those skilled in the art, the financial institution serves as stop-gap for loan requests that are not fully funded but meet the financial institution's credit strategy, fulfilling the uncommitted portion of the loan requests. Benefits include, for example, a significant increase in loan closings as otherwise unsatisfied loan requests gain a second opportunity, more options for a blended rate for individual consumer borrowers, and additional pressure on individual consumer lenders due to the financial institution involvement, as understood by those skilled in the art. Moreover, the sale of loans, for example, gap filling loans, in a collection, bundle, or pool can reduce risk through diversification and can make, for example, otherwise minor and uneconomical investments of sufficient worth for interest by secondary capital markets, as understood by those skilled in the art.

As understood by those skilled in the art, the embodiments of the present invention are a supplement and addition to a P2P lending websites. Existing P2P lending websites include, for example: Zopa of San Francisco, Calif. (www.us.zopa.com), Lending Club of Sunnyvale, Calif. (www.lendingclub.com), and Prosper (www.prosper.com), as understood by those skilled in the art.

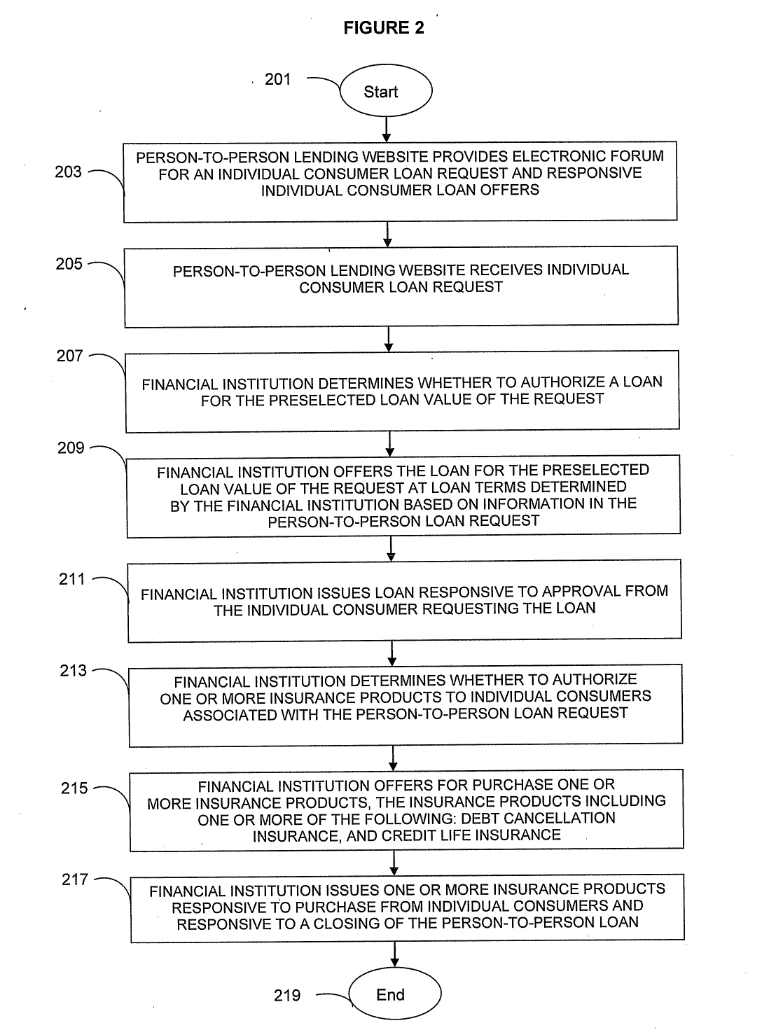

FIG. 2 illustrates another embodiment of the present invention, which, for example, provides a computer-implemented method of satisfying a P2P loan request. The computer-implemented method includes a P2P lending website providing an electronic forum for a P2P loan request by an individual consumer and for loan offers by one or more individual consumers (block 203). The loan request has a preselected loan value. Each loan offer is responsive to the P2P loan request and has a loan value that fulfills all or a portion of the preselected loan value. The computer-implemented method also includes receiving the P2P loan request (block 205). The loan request includes information about the individual consumer making the P2P loan request, as understood by those skilled in the art. The computer-implemented method further includes a financial institution determining whether to authorize a financial institutional loan for the preselected loan value to the individual consumer making the P2P loan request based on the information in the P2P loan request (block 207). The computer-implemented method continues with the financial institution offering the financial institutional loan for the preselected loan value at loan terms determined by the financial institution based on information in the P2P loan request (block 209) so that the individual consumer requesting the loan can choose an immediate loan offer with terms determined by the financial institution or choose to solicit individual consumer loan offers with more favorable terms through the P2P lending website. The computer-implemented method further includes issuing the financial institutional loan responsive to approval by the individual consumer requesting the loan of the terms from the financial institution (block 211). In addition, the computer-implemented method includes the financial institution determining whether to authorize one or more insurance products to individual consumers associated with the P2P loan request (block 213). The computer-implemented method continues with the financial institution offering for purchase one or more insurance products to the individual consumers associated with the P2P loan request (block 215). The insurance products include one or more of the following: debt cancellation insurance, and credit life insurance, as understood by those skilled in the art. Debt cancellation insurance includes a loan term or contractual arrangement modifying loan terms under which a bank agrees to cancel all or part of a customer's obligation to repay an extension of credit upon the occurrence of a specified event, as understood by those skilled in the art. Credit life insurance is a type of insurance, often bought by mortgagors, in which the amount of the policy matches the loan balance at any given time; credit life insurance is designed so that the loan will be paid off in full in the event of death, as understood by those skilled in the art. The computer-implemented method also includes issuing one or more insurance products responsive to a purchase from individual consumers and responsive to a closing of the loan (block 217).

As understood by those skilled in the arts, the immediate financing option provided by the financial institution can guarantee that the loan will be funded (assuming the borrower is willing to accept the terms of the financial institution) and establishes a ceiling on the “zone of possible agreement.” Other benefits of immediate financing embodiments, i.e., prior to a loan auction, and gap filling loan embodiments, i.e., after a loan auction, especially in combination when the borrower is effectively prequalified for the gap filling loan, include an increase in loan closings and an increase in the availability of a blended rate for the borrower. A blended interest rate may or may not exceed the desired rate or a maximum rate of the P2P loan request, as understood by those skilled in the art. The availability of insurance products can reduce lender risk, improve the comfort level of a lender with respect to repayment, and provide assurance to a lender, resulting in a greater willingness to enter into loans, as understood by those skilled in the art.

According to other embodiment of the present invention, the financial institution can be a federally-chartered bank subject to federal banking laws and regulations and not subject to state banking laws and regulations. Therefore, the federally-chartered financial institution enjoys rate preemption; that is, state licensing requirements, as well as regulations in many states that limit lending interest rates, are preempted and do not apply to the federally-chartered financial institution. As understood by those skilled in the art, a federally-chartered financial institution can operate in every state with a consistent implementation nationally rather than a state-by-state approach and can charge any rate for the gap filling loans or immediate financing loans without regard to state law.

Embodiments of the present invention include additional features. As will be understood by those skilled in the art, the financial institution, for example, can employ various levels of sophisticated underwriting models and preselected authorization parameters to determine whether to authorize a gap filling loan, a financial institutional loan for the entire selected loan value, and one or more insurance products to guarantee the loan, according to embodiments of the present invention, so that loan request data is converted into loan offer data. Based on information from the credit reporting agencies that individual lenders on the P2P site would not otherwise have access to or the sophistication to develop, such models, for example, may include a behavior score that considers the borrower's credit score, length of employment, the presence of recent derogatory credit information such as bankruptcy, ability to provide direct deposits to the financial institution, or direct deposit history.

In addition, the financial institution can load the loan value to a prepaid card according to embodiments of the present invention to thereby convert the loan request into a prepaid card having an associated value and being capable of purchasing goods, so that the P2P lending marketplace is not limited to individual consumers with traditional bank accounts, checking accounts, and other such accounts as understood by those skilled in the arts, but expanded to include those using prepaid cards who otherwise may have difficulty in accessing the P2P lending marketplace. Loading the loan value on a prepaid card includes, for example, electronically interfacing with a prepaid card processor, such as, but not limited to FDR, FSV, Galileo, Symmetrex, and TSYS, associated with the prepaid card, as understood by those skilled in the art.

Embodiments of the present invention provide other benefits to the P2P lending website. An association with the financial institution can legitimize the P2P lending website, as understood by those skilled in the arts. The addition of gap filling loans, according to the embodiments of the present invention, allows the P2P lending website to preserve its social feel with the financial institution serving simply as a backstop for both individual consumer borrowers and lenders. Also, reporting the financial institution performance, as understood by those skilled in the art, for example, can create a “Beat the Stuffy, White Shirt Banker” promotional opportunity for the P2P lending website.

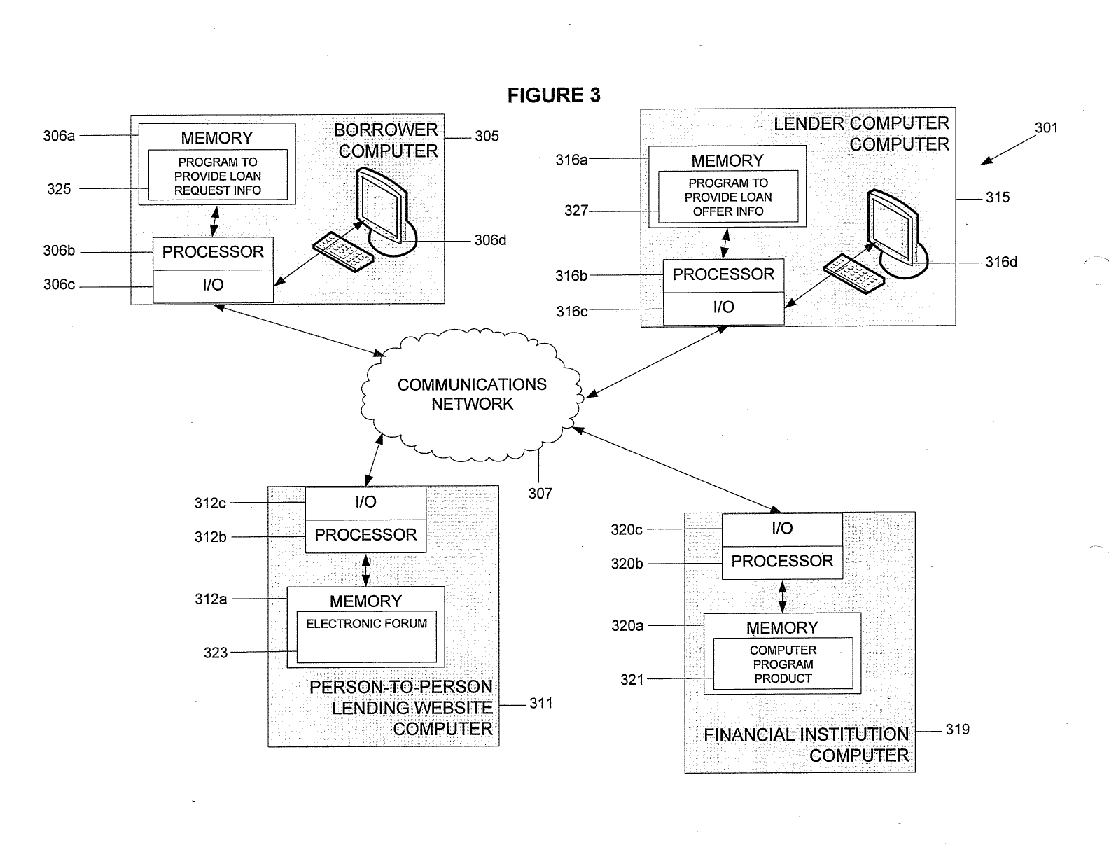

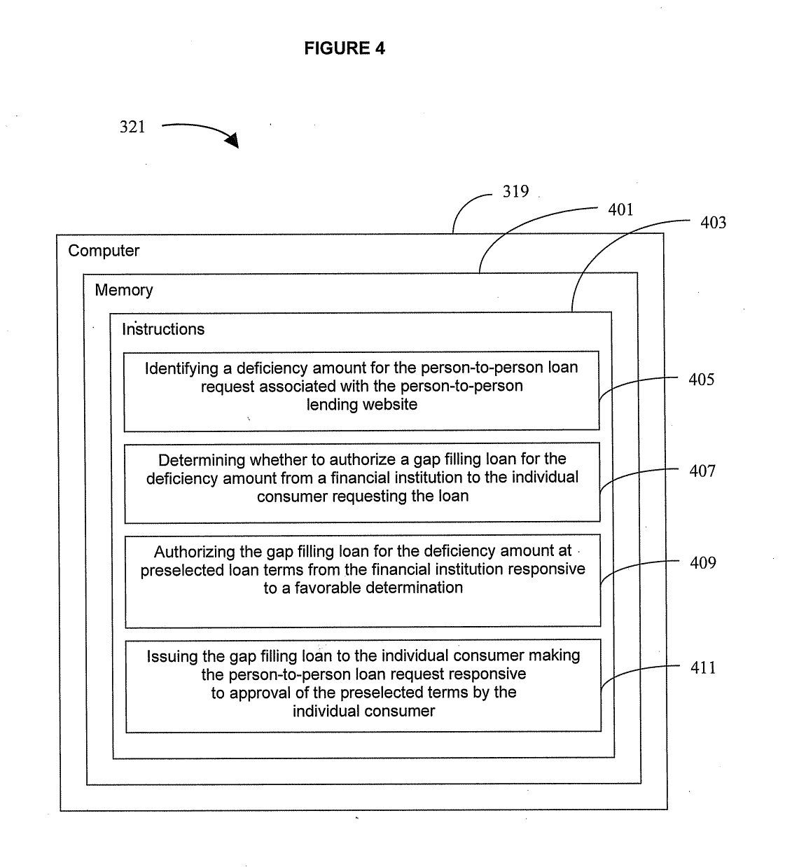

FIGS. 3 and 4 illustrate embodiments of the present invention, which advantageously provide a system 301 to finance an individual consumer loan request associated with a P2P lending website 323. The system 301 includes a first computer associated with an individual consumer borrower defining a borrower computer 305. The borrower computer 305 can have, for example, memory 306a, one or more processors 306b, input/output (I/O) devices 306c, and a display 306d. The borrower computer 305 can also include a program product, e.g., software, stored in memory 306a to provide information for a P2P loan request 325 through an electronic communications network 307, e.g., the Internet or world wide web, to a second computer associated with a P2P lending website 323 defining a P2P lending website computer 311. The P2P lending website computer 311 can have, for example, memory 312a, one or more processors 312b, and input/output (I/O) devices 312c. The P2P lending website computer 311 has an electronic forum 323 for hosting a P2P loan request and for loan offers by one or more individual consumer lenders. The loan request information includes a preselected loan value. Each loan offer associated with the electronic forum 323 is responsive to the P2P loan request and has a loan value that fulfills all or a portion of the P2P the preselected loan value. The system 301 further includes one or more third computers associated with individual consumer lenders defining a lender computer 315. The lender computer 315 can have, for example, memory 316a, one or more processors 316b, input/output (I/O) devices 316c, and a display 316d. The lender computer 315 includes a program product stored in memory 316a to provide loan offer information 327 responsive to the P2P loan request to the P2P lending website computer 311 through the electronic communications network 307. That is, an individual consumer borrower can use, for example, a browser or other application program 325 miming on a computer 305 to access a P2P lending website computer 311; the borrower computer 305 can provide loan request information, as understood by those skilled in the art. Then individual consumer lenders can use, for example, browsers or other application programs 327 running on computers 315 to access the P2P lending website computer 311; the lenders can make offers responsive to the P2P loan request, as understood by those skilled in the art. And the computers all communicate through the Internet, World Wide Web, or other such electronic communications network 307. The system 301 also, for example, can include a fourth computer associated with a financial institution defining a financial institution computer 319. The financial institution computer 319 can have, for example, memory 320a, one or more processors 320b, and input/output (I/O) devices 320c. The financial institution computer 319 receives loan information from the P2P lending website computer 311 through the electronic communications network 307.

As also illustrated in FIG. 4, the financial institution computer 319 includes a computer program product 321 associated with the financial institution computer 319, stored on a tangible computer memory media 401, operable on a computer, and used to finance an individual consumer loan request. The computer program product 421, for example, includes a set of instructions 403 that, when executed by the computer 419, cause the computer 419 to perform various operations. The operations include identifying a deficiency amount for the P2P loan request associated with the P2P lending website (block 405). The deficiency amount is the difference between the preselected loan value of the P2P loan request and a value of an aggregate of any individual consumer loan offers responsive to the. P2P loan request, if the value of the aggregate is less than the preselected loan value. The operations also include determining whether to authorize a gap filling loan for the deficiency amount from a financial institution to an individual consumer requesting the loan (block 407) and authorizing the gap filling loan for the deficiency amount at preselected loan terms from the financial institution (block 409). The operations further include issuing the gap filling loan to the individual consumer making the P2P loan request responsive to approval of the preselected terms by the individual consumer (block 411).

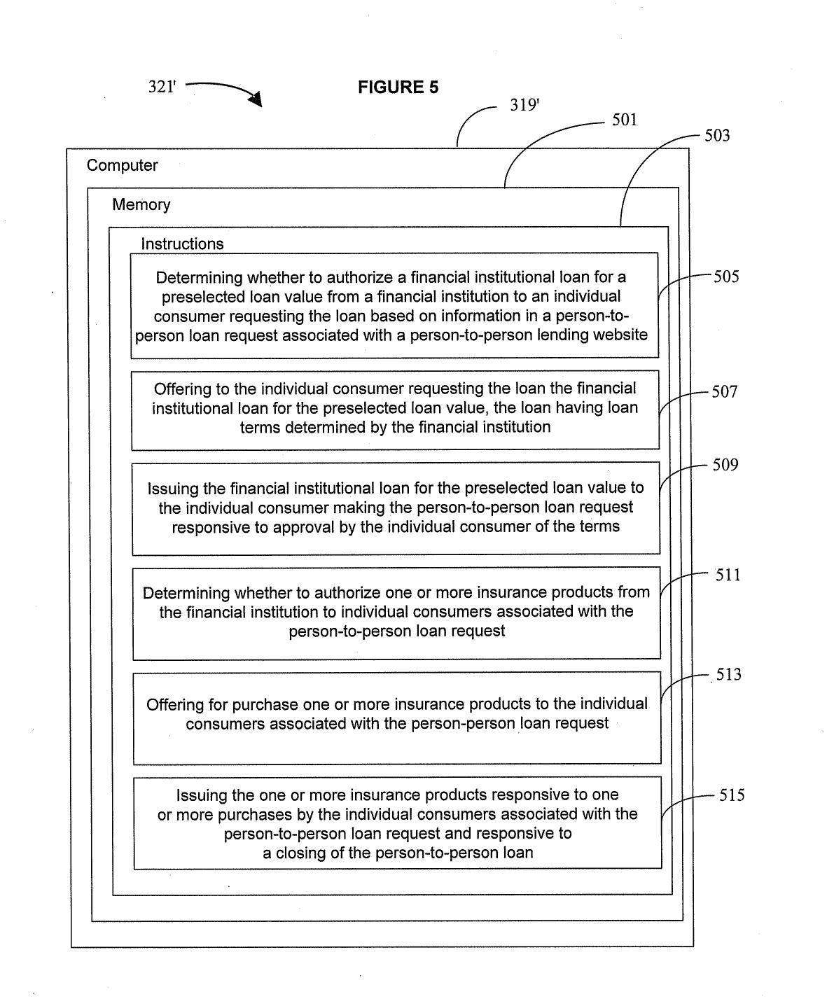

FIG. 5 illustrates another embodiment of a program product of the present invention, which includes a computer program product 321 associated with a financial institution computer 319, stored on a tangible computer memory media 501, operable on a computer, and used to finance an individual consumer loan request. The computer program product 321, for example, includes a set of instructions 503 that, when executed by the computer 319, cause the computer 319 to perform various operations. The operations include determining whether to authorize a financial institutional loan for a preselected loan value from a financial institution to an individual consumer requesting the loan based on information in a P2P loan request (block 505). The operations also include offering to the individual consumer requesting the loan the financial institutional loan for the preselected loan value with loan terms determined by the financial institution based on the information in the P2P loan request (block 507) so that the individual consumer requesting the loan can choose an immediate loan offer with terms determined by the financial institution or choose to solicit individual consumer loan offers with more favorable terms through the P2P lending website. The operations further include issuing the financial institutional loan for the preselected loan value to the individual consumer making the P2P loan request responsive to approval by the individual consumer of the terms from the financial institution (block 509). In addition, the operations include determining whether to authorize one or more insurance products from the financial institution to individual consumers associated with the P2P loan request (block 511). The operations further include offering for purchase one or more insurance products, such as, for example, debt cancellation insurance and credit life insurance (block 513). The operations also include issuing one or more insurance products responsive to one or more purchases by the individual consumers associated with the P2P loan request and responsive to a closing of the loan (block 515).

A person having ordinary skill in the art will recognize that various types of memory are readable by a computer such as described herein, e.g., underwriter computer, bank computer, prepaid card processors, or other computers with embodiments of the present invention. Examples of computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, memory sticks, and other newer types of memories, and transmission type media such as digital and analog communication links. For example, such media can include operating instructions, as well as instructions related to the system and the method steps described above and can operate on a computer. It will be understood by those skilled in the art that such media can be at other locations instead of or in addition to the locations described to store program products, e.g., including software, thereon.

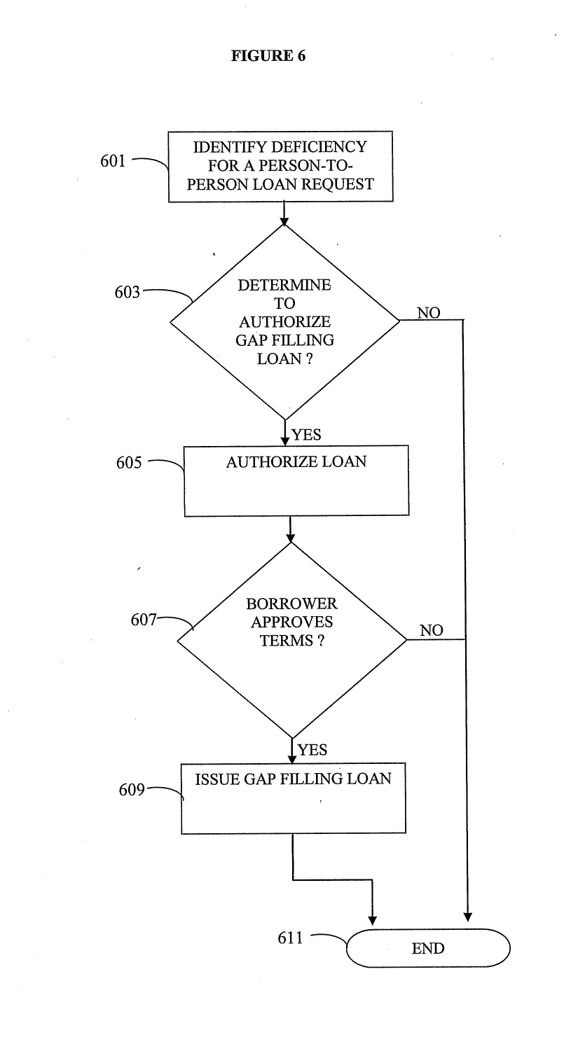

FIG. 6 illustrates an embodiment of the present invention, which includes a process of issuing a gap filling loan from a financial institution, for example. The process includes identifying a deficiency amount for a loan request associated with a P2P lending website (step 601). Next, the decision flow of the process involves determining whether to authorize a gap filling loan for the deficiency amount (block 603). If the determination is not to authorize, the process ends (block 611). If the determination is to authorize, then the financial institution authorizes the gap filling loan (block 605). Next, the decision flow of the process involves asking if the borrower approves the terms from the financial institution (block 607). If the borrower does not, then the process ends (block 611). If the borrower does approve the terms, then the financial institution issues the gap filling loan (block 609). And the process ends (block 611).

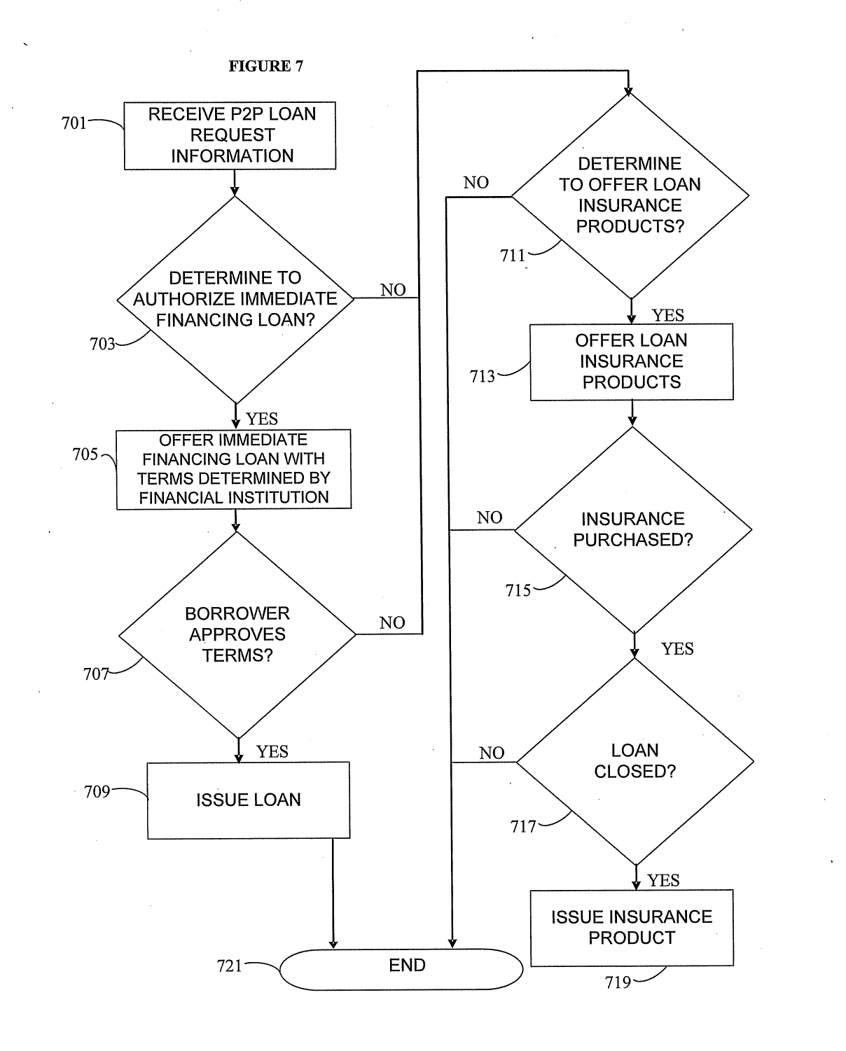

FIG. 7 illustrates another embodiment of the present invention, which includes a process of issuing a loan or insurance product from a financial institution responsive to a P2P loan request, for example. The process includes receiving information in person-person loan request associated with a P2P lending website (step 701). Next, the decision flow of the process involves determining whether to authorize an immediate financing loan from the financial institution (block 703). If the determination is to authorize, then the financial institution offers the immediate financing loan with terms determined by the financial institution (block 705). Next, the decision flow of the process involves asking if the borrower approves the terms from the financial institution (block 707). If the borrower approves the terms, then the financial institution issues the loan (block 709) and the process ends (block 721). If, however, the determination is not to authorize the loan or the borrower does not approve terms, then the process continues with determining whether to offer loan insurance products (block 711). If the determination is not to offer the loan insurance products, the process ends (block 721). If the determination is to offer the loan insurance products, then the financial institution offers the loan insurance products (block 713). Next, the decision flow of the process involves asking if the insurance product is purchased (block 715). If the insurance product purchase is declined, then the process ends (block 721). If the insurance product is purchased, then the decision flow of the process involves asking if the loan closed (block 717). If the loan does not close, then the process ends (block 721). If the loan does close, then the financial institution issues the insurance product (block 719). And the process ends (block 721).

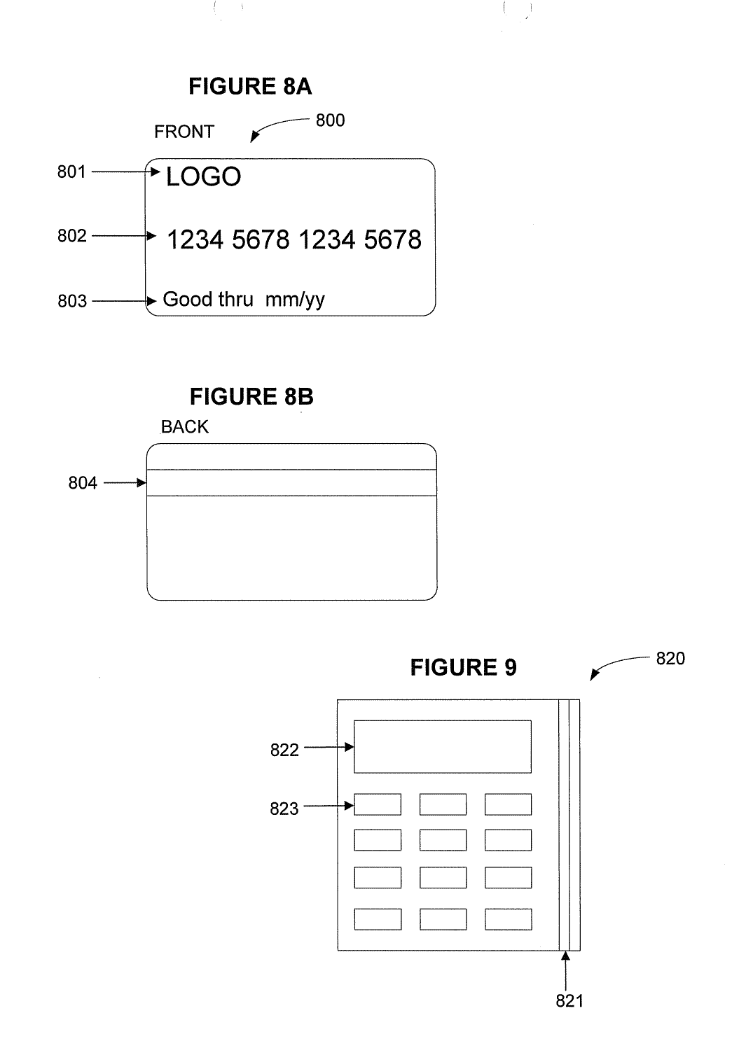

FIGS. 8A and 8B illustrate a prepaid card 800, according to an embodiment of the present invention. FIGS. 9 illustrates a point-of-sale hardware device 820, e.g., a card reader, according to an embodiment of the present invention. As understood by those skilled in the art, the prepaid card can have indicia 801, e.g., logos, slogans, source identifiers, of a sponsoring bank and of a prepaid card processor; a serial number 802, e.g., an account number; and expiration date 803. The structures of various types of specific cards, e.g., magnetic stripe 804, type of material, are well known to those skilled in the art and can be used with embodiments of the present invention. Typically, a card 800 is formed from plastic and has a magnetic stripe 804 affixed to the plastic through an application of heat. Those skilled in the art will understand that other embodiments besides a magnetic stripe can include radio frequency identification devices (RFID), smart chips, bar codes, and other similar devices. Embodiments of the present invention can include forming cards or receiving cards already formed. A magnetic stripe card 800 can store information, or data, e.g., account information, by modifying the magnetism of particles on the magnetic stripe 804 on the card. The information can be read by swiping the card with a point-of-sale hardware device 820. The point-of-sale hardware device 820 can include, for example, interface buttons 823 for use by the merchant personnel or the consumer, a display 822 for providing feedback, and a slot 821 for swiping the card to engage the magnetic stripe 804 on the card with the reader as understood by those skilled in the art. Typically, there are two tracks of information on a magnetic card used for financial transactions, known as tracks 1 and 2. In addition, a third track, known as track 3, can be available for magnetic stripe cards. Tracks 1 and 3, if available, are typically recorded at 210 bits per inch, while track 2 typically has a recording density of 75 bits per inch. Track 2, as typically encoded, was developed by the American Bankers Association (ABA) provides for 37 numeric data characters, including up to 19 digits for a primary account number (including a Bank Identification Number as understood by those skilled in the art), an expiration date, a service code, and discretionary verification data, such as, a Personal Identification Number, or PIN. The information on the card can be used, for example, to facilitate a transaction. For example, when the prepaid card 800 is swiped through a point-of-sale device 820, the information on the magnetic stripe 804 is read and processed by the reader allowing a value associated with the prepaid card to be used to purchase goods and services. In addition, the point-of-sale hardware device 820, through its display 822, can represent a visual depiction of the financial institution loan value loaded onto the prepaid card 800.

Advantageously, embodiments of the present invention, for example, can transform data associated with an individual consumer requesting a loan into an offer for a financial institution loan then into data representing a loan and accordingly into data associated with a value on a prepaid card, resulting in the consumer being able to, for example, perform a home improvement project, take a vacation, enroll in school, or other such purpose provided in the loan request data. That is, the loan request data can be transformed into a new garage or replacement windows according to embodiments of the present invention.

Embodiments of the present invention provide additional benefits for the financial institution, for example, including a low cost customer acquisition channel and cross marketing opportunities for other products and services. As understood by those skilled in the arts, the financial institution can purchase receivables from the individual consumer lenders, forming a secondary market and providing individual consumer lenders the ability to access cash tied up in loans. Additionally, the financial institution can share its sophisticated underwriting models and preselected authorization parameters with individual consumer lenders wanting to piggyback on the financial institution's credit standards according to embodiments of the present invention, further legitimizing the P2P lending website and the underwriting and performance data reported by the P2P lending website, as understood by those skilled in the arts.

This application claims priority to and the benefit of U.S. Provisional Patent Application No. 61/033,069, titled “Person-to-Person Lending Program Product, System, and Associated Methods”, filed on Mar. 3, 2008, incorporated herein by reference in its entirety.

Many modifications and other embodiments of the invention will come to the mind of one skilled in the art having the benefit of the teachings presented in the foregoing descriptions and the associated drawings. Therefore, it is to be understood that the invention is not to be limited to the illustrated embodiments disclosed, and that modifications and other embodiments are intended to be included within the scope of the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A system to finance an individual consumer loan request associated with a person-to-person lending website, the system comprising:
a first computer associated with a financial institution defining a financial institution computer, the financial institution computer having memory, being associated with the electronic communications network, and being positioned to receive and process loan request information from a second computer associated with an electronic forum for person-to-person loans defining a person-to-person lending website computer, the person-to-person lending website computer in communication with a third computer associated with an individual consumer defining a borrower computer and one or more fourth computers associated with individual lenders defining a lender computer, the borrower computer being positioned to provide information for a person-to-person loan request through an electronic communications network, the lender computer positioned to communicate to the person-to-person lending website computer a loan offer responsive to the person-to-person loan request; and
a computer program product associated with the financial institution computer, stored on a tangible, non-transitory computer memory media, operable on a computer, and used to finance an individual consumer loan request associated with a person-to-person lending website, the computer program product comprising a set of instructions that, when executed by the computer, cause the computer to perform the operations of:
receiving information about a person-to-person loan request associated with an electronic forum for person-to-person loans from the person-to-person lending website computer, the loan request from an individual consumer and having a preselected loan value,
determining whether to authorize a financial institutional loan from a financial institution to the individual consumer requesting the loan responsive to information in the person-to-person loan request,
offering to the individual consumer requesting the loan the financial institutional loan, the loan offer having loan terms determined by the financial institution responsive to the information in the person-to-person loan request, and
issuing the financial institutional loan to the individual consumer making the person-to-person loan request responsive to approval by the individual consumer of the terms from the financial, institution so that the person-to-person loan request is converted into proceeds from a financial institution loan.

22. A system of claim 21, wherein the operation of offering to the individual consumer requesting the loan the financial institutional loan includes offering a loan having the preselected loan value to the consumer prior to the loan request being posted on the person-to-person lending website so that the individual consumer requesting the loan can choose an immediate loan offer with terms determined by the financial institution or choose to solicit individual consumer loan offers with more favorable terms through the person-to-person lending website.

23. A system of claim 21, wherein the operation of offering to the individual consumer requesting the loan the financial institutional loan includes:
identifying a deficiency amount for the person-to-person loan request associated with the person-to-person lending website, the deficiency amount being the difference between the preselected loan value of the person-to-person loan request and a value of an aggregate of any individual consumer loan offers responsive to the person-to-person loan request and associated with the person-to-person lending website, the value of the aggregate being less than the preselected loan value; and
offering to the individual consumer requesting the loan a gap filling loan from a financial institution for the deficiency amount from a financial institution the loan offer having loan terms determined by the financial institution responsive to the information in the person-to-person loan request so that the loan request can be partially satisfied by individual consumer loan offers.

24. A system of claim 21, wherein the computer program product further comprises a set of instructions that, when executed by the computer, cause the computer to perform the operations of:
determining whether to authorize one or more insurance products from the financial institution to individual consumers associated with the person-to-person loan request;
offering for purchase one or more insurance products to the individual consumers associated with the person-to-person loan request, the insurance products including one or more of the following: debt cancellation insurance, and credit life insurance; and
issuing one or more insurance products responsive to one or more purchases by the individual consumers associated with the person-to-person loan request and responsive to a closing of the loan.

25. A. system of claim 21, wherein the operation of issuing the financial institutional loan to the individual consumer making the person-to-person loan request includes loading the loan value to a prepaid card to thereby convert the loan request into a prepaid card having an associated value and being capable of purchasing goods.

26. A system of claim 21, wherein the person-to-person lending website solicits person-to-person loan requests having a maximum interest rate and responsively solicits loan offers having an interest rate, the loan offer interest rate being less than or equal to the loan request maximum interest rate so that individual consumers can compete to fulfill the person-to-person loan request; wherein determining whether to authorize a financial institutional loan from a financial institution to the individual consumer requesting the loan responsive to information in the person-to-person loan request includes one or more preselected authorization parameters being related to a loan underwriting model; and wherein the financial institution is a federally-chartered bank subject to federal banking laws and regulations and not subject to state banking laws and regulations.

27. A computer program product associated with a financial institution computer, stored on a tangible, non-transitory computer memory media, operable on the financial institution computer, and used to perform a process of offering, by a financial institution associated with the financial institution computer, a financial institution loan to an individual consumer making an individual consumer loan request using a borrower computer in electronic communication with an electronic forum for person-to-person loans operated by a person-to-person lending website computer and a process of financing the individual consumer loan request, the computer program product, comprising a set of instructions that, when executed by the computer, cause the computer to perform the operations of:
receiving, from the person-to-person lending computer, information about a person-to-person loan request associated with the electronic forum for person-to-person loans, the loan request from an individual consumer to solicit a plurality of lenders for the person-to-person loans, and having a preselected loan value;
determining whether to authorize the financial institutional loan from the financial institution to the individual consumer requesting the person-to-person loan responsive to information in the person-to-person loan request;
offering to the individual consumer requesting the person-to-person loan the financial institutional loan, the financial institution loan offer having loan terms determined by the financial institution responsive to the information in the person-to-person loan request; and issuing the financial institutional loan to the individual consumer making the person-to-person loan request responsive to approval by the individual consumer of the terms from the financial institution so that the person-to-person loan request is converted into proceeds from a financial institution loan.

28. A computer program product of claim 27, wherein the operation of offering to the individual consumer requesting the loan the financial institutional loan includes offering a loan having the preselected loan value to the consumer prior to the loan request being posted on the person-to-person lending website so that the individual consumer requesting the loan can choose an immediate loan offer with terms determined by the financial institution or choose to solicit individual consumer loan offers with more favorable terms through the person-to-person lending website.

29. A computer program product of claim 27, wherein the operation of offering to the individual consumer requesting the loan, the financial institutional loan includes:
identifying a deficiency amount for the person-to-person loan request associated with the person-to-person lending website, the deficiency amount being the difference between the preselected loan value of the person-to-person loan request and a value of an aggregate of any individual consumer loan offers responsive to the person-to-person loan request and associated with the person-to-person lending website, the value of the aggregate being less than the preselected loan value; and
offering to the individual consumer requesting the loan a gap filling loan from a financial institution for the deficiency amount from a financial institution, the loan offer having loan terms determined by the financial institution responsive to the information in the person-to-person loan request so that the loan request can be partially satisfied by individual consumer loan offers.

30. A computer program product of claim 27, further comprising a set of instructions that, when executed by the computer, cause the computer to perform the operations of:
determining whether to authorize one or more insurance products from the financial institution to individual consumers associated with the person-to-person loan request;
offering for purchase one or more insurance products to the individual consumers associated with the person-to-person loan request, the insurance products including one or more of the following: debt cancellation insurance, and credit life insurance; and
issuing the one or more insurance products responsive to one or more purchases by the individual consumers associated with the person-to-person loan request and responsive to a closing of the loan.

31. A computer program product of claim 27, wherein the operation of issuing the financial institutional loan to the individual consumer making the person-to-person loan request includes loading the loan value to a prepaid card to thereby convert the loan request into a prepaid card having an associated value and being capable of purchasing goods.

32. A computer program product of claim 27, wherein the person-to-person lending website solicits person-to-person loan requests having a maximum interest rate and responsively solicits loan offers having an interest rate, the loan offer interest rate being less than or equal to the loan request maximum interest rate so that individual consumers can compete to fulfill the person-to-person loan request; wherein determining whether to authorize a financial institutional loan from a financial institution to the individual consumer requesting the loan responsive to information in the person-to-person loan request includes one or more preselected authorization parameters being related to a loan underwriting model; and wherein the financial institution is a federally-chartered bank subject to federal banking laws and regulations and not subject to state banking laws and regulations.

33. A computer-implemented method of satisfying a person-to-person loan request, the computer-implemented method operable on a computer defining a financial institution computer associated with a financial institution and being used to perform a process of offering, by the financial institution associated with the financial institution computer, a financial institution loan to an individual consumer making an individual consumer loan request using a borrower computer in electronic communication with an electronic forum for person-to-person loans operated by a person-to-person lending website computer and a process of financing the individual consumer loan request, the computer-implemented method performing the steps of:
receiving, from the person-to-person lending computer, information about a person-to-person loan request associated with the electronic forum for person-to-person loans, the loan request from an individual consumer to solicit a. plurality of lenders for the person-to-person loans, and having a preselected loan value;
determining whether to authorize the financial institutional loan from the financial institution to the individual consumer requesting the person-to-person loan responsive to information in the person-to-person loan request;
offering to the individual consumer requesting the person-to-person loan the financial institutional loan, the financial institution loan offer having loan terms determined by the financial institution responsive to the information in the person-to-person loan request; and issuing the financial institutional loan to the individual consumer making the person-to-person loan request responsive to approval by the individual consumer of the terms from the financial institution so that the person-to-person loan request is converted into proceeds from a financial institution loan.

34. A computer-implemented method of claim 33, wherein the step of offering to the individual consumer requesting the loan the financial institutional loan by the financial institution computer includes offering a loan having the preselected loan value to the consumer prior to the loan request being posted on the person-to-person lending website so that the individual consumer requesting the loan can choose an immediate loan offer with terms determined by the financial institution or choose to solicit individual consumer loan offers with more favorable terms through the person-to-person lending website.

35. A computer-implemented method of claim 33, wherein the step of offering to the individual consumer requesting the loan the financial institutional loan by the financial institution computer includes:
identifying a deficiency amount for the person-to-person loan request associated with the person-to-person lending website, the deficiency amount being the difference between the preselected loan value of the person-to-person loan request and a value of an aggregate of any individual consumer loan offers responsive to the person-to-person loan request and associated with the person-to-person lending website, the value of the aggregate being less than the preselected loan value; and
offering to the individual consumer requesting the loan a gap-filling loan from a financial institution for the deficiency amount from a financial institution, the loan offer having loan terms determined by the financial institution responsive to the information in the person-to-person loan request so that the loan request can be partially satisfied by individual consumer loan offers.

36. A computer-implemented method of claim 33, further comprising:
determining whether to authorize one or more insurance products from the financial institution to individual consumers associated with the person-to-person loan request;
offering for purchase one or more insurance products to the individual consumers associated with the person-to-person loan request, the insurance products including debt cancellation insurance; and
issuing the one or more insurance products responsive to one or more purchases by the individual consumers associated with the person-to-person loan request and responsive to a closing of the loan.

37. A computer-implemented method of claim 33, further comprising:
determining whether to authorize one or more insurance products from the financial institution to individual consumers associated with the person-to-person loan request;
offering for purchase one or more insurance products to the individual consumers associated with the person-to-person loan request, the insurance products including credit life insurance; and
issuing the one or more insurance products responsive to one or more purchases by the individual consumers associated with the person-to-person loan request and responsive to a closing of the loan.

38. A computer-implemented method of claim 33, wherein the step of issuing the financial institutional loan to the individual consumer making the person-to-person loan request includes loading the loan value to a prepaid card to thereby convert the loan request into a prepaid card having an associated value and being capable of purchasing goods.

39. A computer-implemented method of claim 18, further comprising a reader reading data on the prepaid card to access the loan value on the prepaid card to represent a visual depiction of the loan value on a display associated with the reader and to complete a transaction of goods to thereby convert the data on the prepaid card into goods.

40. A computer-implemented method of claim 33, wherein the person-to-person lending website solicits person-to-person loan requests having a maximum interest rate and responsively solicits loan offers having an interest rate, the loan offer interest rate being less than or equal to the loan request maximum interest rate so that individual consumers can compete to fulfill the person-to-person loan request; wherein determining whether to authorize a financial institutional loan from a financial institution to the individual consumer requesting the loan responsive to information in the person-to-person loan request includes one or more preselected authorization parameters being related to a loan underwriting model so that loan request data is converted into loan offer data; and wherein the financial institution is a federally-chartered bank subject to federal banking laws and regulations and not subject to state banking laws and regulations.
